(19) United States
(12) Patent Application Publication
(10) Pub. No.: US 2025/0368575 A1
(43) Pub. Date: Dec. 4, 2025

(54) GEOPOLYMER COMPOSITE FOR SUBGRADE APPLICATIONS

(71) Applicants: Elham Fini, Phoenix, AZ (US); Farideh Pahlavan, Chandler, AZ (US); Sand Aldagari, Tempe, AZ (US)

(72) Inventors: Elham Fini, Phoenix, AZ (US); Farideh Pahlavan, Chandler, AZ (US); Sand Aldagari, Tempe, AZ (US)

(21) Appl. No.: 19/226,947

(22) Filed: Jun. 3, 2025

Related U.S. Application Data
(60) Provisional application No. 63/655,459, filed on Jun. 3, 2024.

(51) Int. Cl. C04B 20/10; C04B 16/04; C04B 18/20; C04B 20/02; C04B 28/00; C08J 3/12

(52) U.S. Cl. CPC C04B 20/1055; C04B 16/04; C04B 18/20; C04B 20/023; C04B 28/006; C08J 3/128; C08J 2367/02

(57) ABSTRACT

Treating plastic particles includes combining a bio-oil with the plastic particles to yield a mixture, heating the mixture to couple the bio-oil to the plastic particles, and coating the plastic particles with a biochar to yield modified plastic granules. The modified plastic granules include plastic particles with adsorbed bio-oil and a biochar coating. Preparing a geopolymer composite includes combining modified plastic granules, copper tailings, and an alkali solution to yield the geopolymer composite. A composite material includes a construction base material and a geopolymer composite including modified plastic granules and copper tailings.

### CROSS-REFERENCE TO RELATED APPLICATION

This application claims the benefit of U.S. Patent Application No. 63/655,459 filed on Jun. 3, 2024, which is incorporated by reference herein in its entirety.

### STATEMENT OF GOVERNMENT SUPPORT

This invention was made with government support under 2121160 awarded by the National Science Foundation. The government has certain rights in the invention.

### TECHNICAL FIELD

This invention relates to a carbon composite used to modify construction materials.

### BACKGROUND

Cement, an ingredient of concrete, is used in infrastructure, including foundations, pavement layers, bridges, pipelines, and dams. Cement curing is typically driven by cement hydration, which can lead to strength and durability. However, the inherent presence of water within concrete can lead to internal stresses and cracks in cold temperature applications, as the water freezes and expands. These aberrations can compromise the strength and durability of concrete.

### SUMMARY

The present disclosure describes a method for preparing modified plastic granules from waste plastic, bio-oil, and biochar. Combining the modified plastic granules with copper tailings and an alkali solution yields a geopolymer composite, which can provide low-carbon alternatives for construction materials (e.g., concrete), sustainable infrastructure in cold climates, and mitigation of environmental risks and health hazards associated with mine tailings disposal.

In a first general aspect, treating plastic particles includes combining a bio-oil with the plastic particles to yield a mixture, heating the mixture to couple the bio-oil to the plastic particles, and coating the plastic particles with a biochar to yield modified plastic granules.

Implementations of the first general aspect may include one or more of the following features. In some cases, the mixture is allowed to stand at ambient temperature for about 12 hours prior to heating. The mixture can be stirred before and after each heating. In certain implementations, the mixture is stirred for a length of time between 1 minute and 100 minutes. The heating can include heating by microwave radiation. In certain cases, the microwave radiation is applied twice for about 5 minutes. The microwave radiation can be applied at about 400 Watts. In some implementations, the mixture is washed with organic solvent after heating is complete. The washing with organic solvent can be carried out twice. A suitable example of the organic solvent includes acetone. In certain examples, the washing can be carried out for about 5 minutes. In some cases, the mixture is dried after it is heated with the bio-oil and washed with the organic solvent. The drying can be carried out at about 60° C.

In some cases, coating the plastic particles with the biochar includes contacting the plastic particles with a slurry including biochar, organic solvent, and water. Preparing the slurry can include combining the biochar with organic solvent and water. In some implementations, the slurry includes acetone and water (e.g., 60 wt % acetone and 40 wt % water). The slurry can include a weight ratio of the biochar to the plastic particles in a range of about 1:2 to about 1:4. In some examples, the first general aspect can further include stirring and sonicating the slurry with heating prior to contacting the slurry with the plastic particles. The slurry can be stirred for about 10 minutes and sonicated for about 15 minutes at a temperature of about 50° C., prior to contacting with the plastic particles. Contacting the plastic particles with the slurry can include sequentially stirring, standing, and sonicating with heating. In some cases, the stirring occurs for about 10 minutes. In certain implementations, the standing occurs at ambient temperature for about 24 hours. The sonicating can occur for about 15 minutes to about 90 minutes with the heating at a temperature of about 50° C.

The modified plastic granules can be obtained by drying the mixture including the slurry and the treated plastic particles after sequentially stirring, standing, sonicating, and heating. The drying can be carried out at a temperature of about 100° C. for about 1 hour. A weight ratio of the plastic particles to the bio-oil can be in a range of about 1:1 to about 1:2. In some cases, the plastic particles include at least one polyester polymer. The plastic particles can include polyethylene terephthalate. In some implementations, the plastic particles include plastic waste. The plastic particles can include flakes having a dimension in a range of about 5 mm to about 30 mm.

In a second general aspect, modified plastic granules include plastic particles with adsorbed bio-oil and a biochar coating.

Implementations of the second general aspect may include one or more of the following features. In some cases, the plastic particles include at least one polyester polymer. The plastic particles can include polyethylene terephthalate. In some examples, the plastic particles include waste plastic. The plastic particles can include flakes having a dimension in a range of about 5 mm to about 30 mm. The modified plastic granules can be prepared using the first general aspect.

In a third general aspect, preparing a geopolymer composite includes combining modified plastic granules of the second general aspect, copper tailings, and an alkali solution to yield the geopolymer composite.

Implementations of the third general aspect may include one or more of the following features. In some cases, the modified plastic granules include plastic particles with adsorbed bio-oil and a biochar coating. The modified plastic granules can include the modified plastic granules of the second general aspect. In certain implementations, the copper tailings include copper tailing without slag. A suitable example of the alkali solution includes aqueous NaOH.

In a fourth general aspect, a composite material includes a construction base material and a geopolymer composite including modified plastic granules and copper tailings.

Implementations of the fourth general aspect may include one or more of the following features. The construction base material can include cement. In some cases, the geopolymer composite includes the geopolymer composite prepared by the third general aspect. The geopolymer composite can include modified plastic granules and copper tailings. In some implementations, the geopolymer composite includes modified plastic granules and copper tailings without slag. The geopolymer composite can include the modified plastic granules of the second general aspect.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a flow chart showing operations in a process for treating plastic particles.

FIGS. 2A, 2B, and 2C show a flow chart of an example method of treating plastic particles to yield modified plastic granules.

FIG. 3 shows freezing point of silt in comparison to the psychrophile, bio-oil treated plastic granules (OTPG), and biochar-coated OTPG (C-OTPG).

FIG. 4A shows ice shape patterns in C-OTPG. FIG. 4B shows ice shape patterns in silts. FIG. 4C shows disturbed ice nucleation by the presence of C-OTPG in silts. FIG. 4D shows disturbed ice nucleation by the presence of C-OTPG in silts.

### DETAILED DESCRIPTION

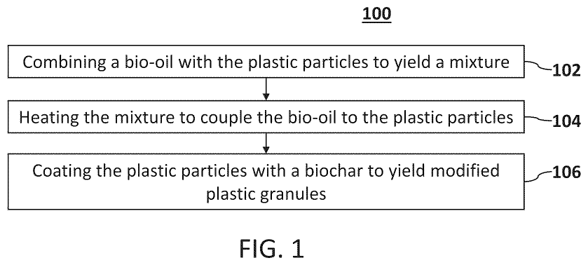

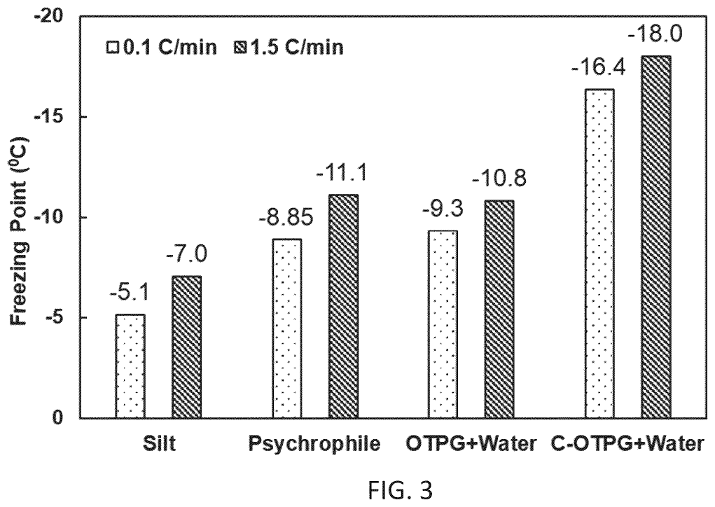

This disclosure describes a reduction of ice crystal formation in construction materials (e.g., concrete) by utilizing bio-oil treated plastic granules (OTPG) coated with biochar (“modified plastic granules”). These modified plastic granules are produced from waste plastic in a process such as that shown in FIG. 1. The enhanced thermal characteristics of OTPG and of biochar-coated OTPG (C-OTPG) are demonstrated by a reduction in freezing point of various materials (e.g., silt, psychrophile, OTPG, C-OTPG), as shown in FIG. 3. Modified plastic granules can be combined with copper turnings in the presence of a base (e.g., NaOH) to yield a geopolymer composite. When this geopolymer composite is combined with cement or concrete to yield a geopolymer composite blend, the resulting material exhibits enhanced thermal properties.

Cement is a major component of concrete, which plays a role in civil infrastructure, including foundations, pavement layers, bridges, pipelines, and dams. The curing process of cement is typically driven by water through cement hydration and contributes to concrete's strength and durability. However, in cold climates, the presence of water within the concrete mixture introduces challenges. Freezing temperatures can cause water to freeze and expand, leading to the creation of internal stresses and cracks that damage the concrete structure. These conditions in cold regions present challenges, including changing arctic frontiers, thaw-weakening of soils, differential frost-heave, deicing chemicals, bio-corrosion, and atmospheric corrosion hazards. Considerable financial resources are spent annually to repair the distress induced by the freeze-thaw phenomena on highway infrastructure, leading to extensive rehabilitation efforts, chemical treatments, and conservative design approaches to keep cold-region infrastructure in serviceable conditions. These ongoing efforts not only impose an economic burden but also have adverse environmental impacts (e.g., contaminating surface and groundwater and affecting wildlife and vegetation). Moreover, cement, as the stabilization material, contributes to greenhouse gas emissions, both directly and indirectly, posing further challenges to environmental sustainability and climate adaptability in cold regions.

Waste in the form of plastics represents a source of potential construction material. Likewise, waste in the form of copper tailings, represents a source of potential construction material if modified appropriately. Valorization of plastic waste and copper tailings as a potential source of construction material offers a means of reducing potential environmental and health risks associated with land fill or copper mine field leaching.

Biochar is a porous and solid carbonaceous substance obtained through the thermal decomposition of biomass under restricted oxygen conditions. Classified as a form of biocarbon, biochar encompasses diverse carbon materials from biological sources such as plants, animals, and microbes. Examples of sources of biochar include algae, wood, shells, crops, crop waste, and other organic waste (e.g., from paper mills, sawmills, or breweries).

Bio-oil is derived from renewable biological sources, such as plants, algae, and organic waste materials. Bio-oil is derived through the pyrolysis of plant material or through hydrothermal liquefaction of biomass including plants, animals, and/or waste thereof.

The present disclosure provides a low-carbon composite of bio-oil treated plastic granules coated with biochar (modified plastic granules) with copper tailings. In some cases, the copper tailings are without slag. The copper tailings are typically bound in the composite by an alkali activation process. The alkali activation process can include aqueous sodium hydroxide (NaOH). This fusion of biomass, waste plastics, and copper tailings provides a geopolymer composite that when blended with cement or concrete, yields construction materials with improved durability and performance at sub-zero temperatures. By integrating the modified plastic granules into a geopolymer composite, plastic waste is diverted from landfills. In addition, the modified plastic granules can immobilize plausible metal leachate from mine tailings used in the geopolymer composite.

FIG. 1 is a flow chart showing operations in process 100 for treating plastic particles. In 102, plastic particles are combined with a bio-oil to yield a mixture. The plastic particles can include waste plastic. In some cases, the plastic particles include at least one polyester polymer. In some implementations, the plastic particles contain one or more different types of polyester polymers. Suitable examples of polyesters include polybutylene terephthalate, polyethylene terephthalate, polytrimethylene terephthalate, polybutylene isophthalate, polypropylene isophthalate, polyethylene isophthalate, polybutylene phthalate, polypropylene phthalate, and polyethylene phthalate. In some examples, the plastic particles can contain one or more different type of polymers. Suitable examples of these different types of polymers include polyamides, polyesters, polycarbonates, polystyrenes, polyphthalates, polylactic acid, polyvinyl alcohol (PVA), polyurethanes, acetonitrile butadiene styrene copolymer (ABS), polyaryl ether ketone, polyether imides, polyimide, polypropylene, polyethylene, polyether block amide, polyetherketoneketone, and polyacrylates. The plastic particles typically include particles with a dimension of about 5 mm to about 30 mm. The plastic particles can be in the form of flakes, shards, or shreds. In some cases, the weight ratio of plastic particles to bio-oil is about 1:1.

In 104, the mixture is heated to couple the bio-oil to the plastic particles. The mixture is typically allowed to stand at ambient temperature for a length of time (e.g., 12 hours) prior to heating. In certain cases, the mixture is stirred before and after each heating for a length of time between 1 minute and 100 minutes. In some implementations, heating includes heating by infrared or microwave radiation. The microwave radiation is typically applied at about 400 Watts for about 5 minutes. After heating is complete, the mixture is typically washed with an organic solvent (e.g. acetone) for about 5 minutes. In some cases, the mixture is washed twice with the organic solvent. After heating and washing, the mixture is typically dried at about 60° C.

In 106, the plastic particles are coated with a biochar to yield modified plastic granules. The biochar can be obtained from biowaste (e.g., food waste, algae biomass, or animal waste). In some cases, the coating of the plastic particles with the biochar includes contacting the plastic particles with a slurry that includes biochar, organic solvent (e.g., acetone), and water. Preparing the slurry typically includes combining the biochar and a mixture of acetone and water (e.g., 60 wt % acetone and 40 wt % water). The slurry can include a weight ratio of the biochar to the plastic particles of about 1:2.

The process 100 can further include stirring, sonicating, and heating the slurry prior to contacting the slurry with the plastic particles. In certain implementations, the slurry is stirred for about 10 minutes, sonicated for about 15 minutes, and heated at a temperature of about 50° C. prior to contacting the plastic particles. Contacting the plastic particles with the slurry can include sequentially stirring, standing, sonicating, and heating the plastic particles with the slurry. In some cases, the stirring occurs for about 10 minutes. The standing of the plastic particles with the slurry can be at ambient temperature for about 24 hours. In certain cases, the sonicating occurs for about 15 minutes to about 90 minutes. The heating typically occurs at a temperature of about 50° C.

The modified plastic granules are typically obtained by drying the plastic granules with the slurry. In certain implementations, the drying is carried out at a temperature of about 100° C. and occurs for about 1 hour. The modified plastic granules include plastic particles with adsorbed bio-oil and a biochar coating.

### EXAMPLES

### Example 1. Preparation of Modified Plastic Granules

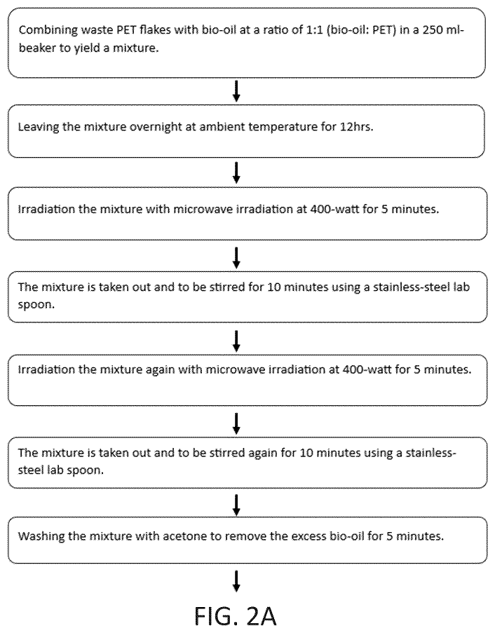

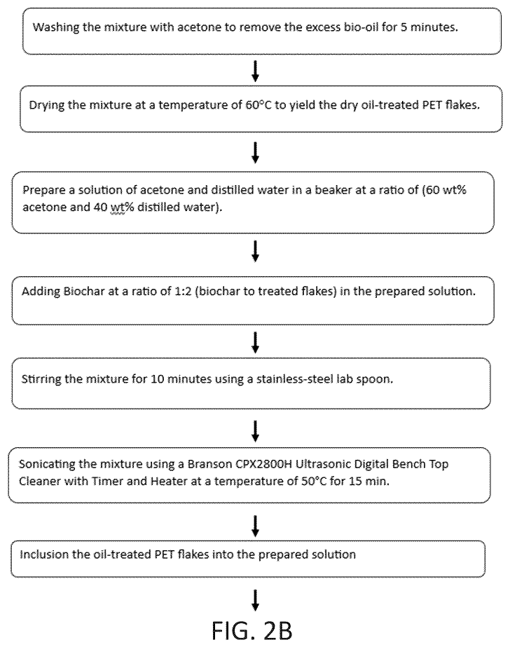

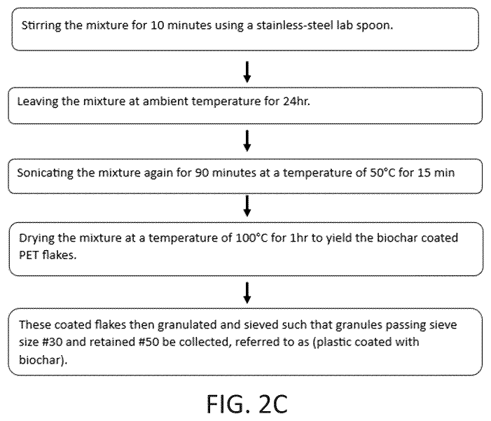

Modified plastic granules were prepared from polyethylene terephthalate. The polyethylene terephthalate flakes were treated with bio-oil under microwave heating, then washed with acetone and treated with a suspension of biochar in a solution of acetone and water. The overall process is shown as a flow-chart in FIGS. 2A, 2B, and 2C. The materials are listed in Table 1.

TABLE 1
Materials

| Materials & Tools | Notes |
|---|---|
| Beaker | 250 mL size |
| Waste Vegetable Oil | |
| Polyethylene terephthalate (PET) | flakes ranging with size |
| flakes | (7 mm-25 mm) |
| Acetone | — |
| Microwave | Power at 400 Watts |
| Biochar | — |
| stainless-steel lab spoon | — |
| blender | used to grind the flakes |
| Two sieves | (No. 30 and No. 50) |
| Distilled water | — |
| Branson CPX2800H Ultrasonic machine | — |

The freezing point depression of different materials are shown in FIG. 1. The C-OTPG exhibited freezing point depression in comparison to silts, uncoated OTPG, and a cold-active Gram-negative psychrophile that is well-adapted to frozen environments and a component of glacial microbiomes. The thermal characterization of C-OTPG demonstrated that the utilization of C-OTPG can alter the phase changes of porous media on different minerals and enhance the service life of infrastructure in cold regions.

The thermal characteristics and ice inhibition of siliceous, and aluminosilicate minerals in presence of C-OTPG were assessed. A thermoelectrically controlled cooling device was used to characterize the freezing, thawing, and thermal hysteresis of ice-nucleating minerals (siliceous and alumina silicate) with different dosages of C-OTPG.

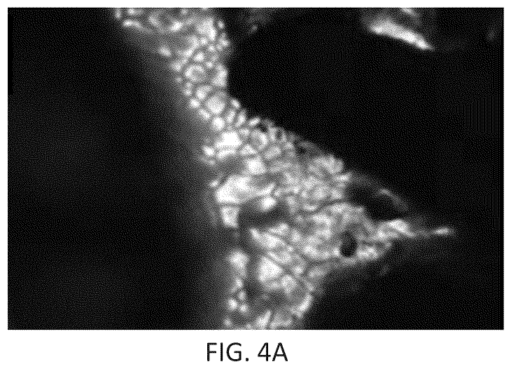

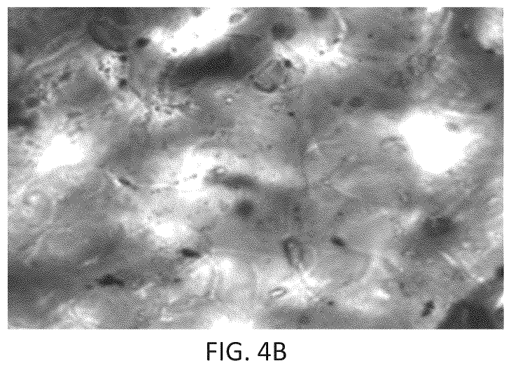

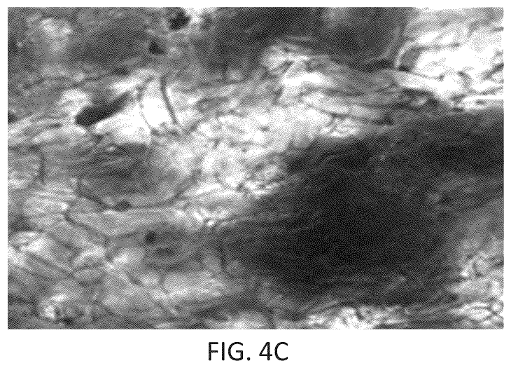

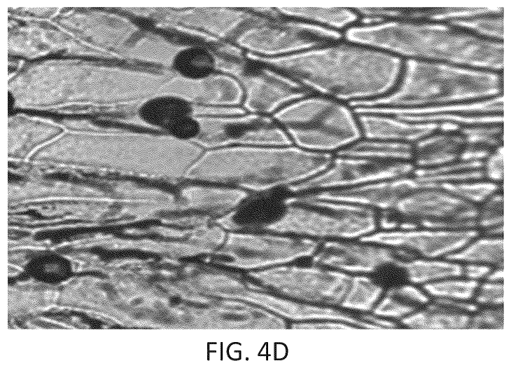

To compare the effect of the functional groups in C-OTPG on the ice crystal shapes, various ice crystal shape formation processes were evaluated. In the C-OTPG, small hexagon ice crystals formed below −16° C., as shown in FIG. 4A. For silts, numerous ice shape patterns were observed. Referring to FIG. 4B, larger hexagonal ice crystals than those in C-OTPG were observed for siliceous geomaterials. Ice crystal formation in silts with different cations showed elongated to rounded ice shapes, as shown in FIGS. 4C and 4D.

The shape of ice and thawing with seasonal cycles can directly affect the service life of the material. In addition, plastic particles are typically durable when exposed to water, making the C-OTPG a synthetic aggregate that can deter ice formation in materials. The carbon coating of the C-OTPG can further protect the plastic from degradation induced at least in part by the ultraviolet radiation. The ability to inhibit ice formation will alleviate the freeze-thaw degradation of the geomaterials and further enhance the service life of the material, especially in cold regions.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of treating plastic particles, the method comprising:
combining a bio-oil with the plastic particles to yield a mixture;
heating the mixture to couple the bio-oil to the plastic particles; and
coating the plastic particles with biochar to yield modified plastic granules.

2. The method of claim 1, wherein the mixture is stirred before and after each heating.

3. The method of claim 2, wherein the mixture is stirred for a length of time in a range of 1 minute to 100 minutes.

4. The method of claim 1, wherein the heating comprises heating by microwave radiation.

5. The method of claim 1, wherein the coating of the plastic particles with the biochar comprises contacting the plastic particles with a slurry comprising the biochar, an organic solvent, and water.

6. The method of claim 5, wherein preparing the slurry comprises combining the biochar and a mixture of the organic solvent and water.

7. The method of claim 5, wherein the slurry comprises acetone and water.

8. The method of claim 5, wherein the slurry comprises a weight ratio of the biochar to the plastic particles in a range of about 1:2 to about 1:4.

9. The method of claim 5, further comprising stirring, sonicating, and heating the slurry prior to contacting the slurry with the plastic particles.

10. The method of claim 1, wherein a weight ratio of the plastic particles to the bio-oil is in a range of about 1:1 to about 1:2.

11. The method of claim 1, wherein the plastic particles comprise at least one polyester polymer.

12. The method of claim 1, wherein the plastic particles comprise polyethylene terephthalate.

13. The method of claim 1, wherein the plastic particles comprise plastic waste.

14. The method of claim 1, wherein the plastic particles comprise flakes having a dimension in a range of about 5 mm to about 30 mm.

15. The modified plastic granules of claim 1.

16. The modified plastic granules of claim 15, wherein the plastic particles comprise at least one polyester polymer.

17. The modified plastic granules of claim 15, wherein the plastic particles comprise polyethylene terephthalate.

18. The modified plastic granules of claim 15, wherein the plastic particles comprise waste plastic.

19. The modified plastic granules of claim 15, wherein the plastic particles comprise flakes having a dimension in a range of about 5 mm to about 30 mm.

20. A method of preparing a geopolymer composite, the method comprising:
combining the modified plastic granules of claim 15 with copper tailings and an alkali solution to yield the geopolymer composite.

21. The geopolymer composite of claim 20.
